(19) United States
(12) Patent Application Publication
(10) Pub. No.: US 2020/0198534 A1
(43) Pub. Date: Jun. 25, 2020

(54) NOTIFICATION CONTROL APPARATUS, NON-TRANSITORY STORAGE MEDIUM STORING THEREIN COMPUTER PROGRAM, AND IN-VEHICLE SYSTEM

(71) Applicant: PANASONIC INTELLECTUAL PROPERTY MANAGEMENT CO., LTD., Osaka (JP)

(72) Inventors: Katsuyuki ITO, Kanagawa (JP); Yosuke KOBAYASHI, Kanagawa (JP); Koyo MORIYA, Kanagawa (JP); Takao NIHEI, Kanagawa (JP)

(73) Assignee: PANASONIC INTELLECTUAL PROPERTY MANAGEMENT CO., LTD., Osaka (JP)

(21) Appl. No.: 16/717,710

(22) Filed: Dec. 17, 2019

(30) Foreign Application Priority Data
Dec. 19, 2018 (JP) 2018-237302

(51) Int. Cl. B60Q 1/52; B60Q 1/00; B60W 30/18; G06K 9/00; G08G 1/005

(52) U.S. Cl. CPC B60Q 1/525; B60Q 1/0035; B60Q 2400/50; G06K 9/00805; G08G 1/005; B60W 30/18009

(57) ABSTRACT

A notification control apparatus is provided in a vehicle, and includes: a projection controller that controls projection of a crosswalk pattern onto a road ahead of the vehicle; and an erroneous preventer that prevents an erroneous start of the vehicle during a projection period of the crosswalk pattern.

### TECHNICAL FIELD

The present disclosure relates to a notification control apparatus, a non-transitory storage medium storing therein a computer program, and an in-vehicle system.

### BACKGROUND ART

Conventionally, techniques for assisting a pedestrian detected by a vehicle in crossing a road are known. For example, Patent Literature (hereinafter, referred to as “PTL”) 1 discloses a technique of a vehicle, in which, when a pedestrian who possibly crosses a road is detected, it is determined on the basis of presence or absence of an oncoming car and a following vehicle whether or not it is possible for the pedestrian to cross the road, and, when it is determined that it is possible for the pedestrian to cross the road, a crosswalk pattern is projected onto the road to assist the pedestrian in crossing the road.

### CITATION LIST

### Patent Literature

### PTL 1

### Japanese Patent Application Laid-Open No. 2015-143093

### SUMMARY OF INVENTION

### Solution to Problem

A notification control apparatus according to one aspect of the present disclosure is a notification control apparatus provided in a vehicle, and includes: a projection controller that controls projection of a crosswalk pattern onto a road ahead of the vehicle; and an erroneous start preventer that prevents an erroneous start of the vehicle during a projection period of the crosswalk pattern.

A non-transitory storage medium storing therein a computer program according to one aspect of the present disclosure causes a computer mounted in a vehicle to execute processing of: controlling projection of a crosswalk pattern onto a road ahead of the vehicle; and preventing an erroneous start of the vehicle during a projection period of the crosswalk pattern.

An in-vehicle system according to one aspect of the present disclosure is an in-vehicle system provided in a vehicle, and includes: an object detector that detects a pedestrian or a bicycle existing ahead of the vehicle; a projection controller that controls projection of a crosswalk pattern onto a road ahead of the vehicle when the pedestrian or the bicycle is detected; and an erroneous start preventer that prevents an erroneous start of the vehicle during a projection period of the crosswalk pattern.

It should be noted that general or specific embodiments may be implemented as a system, an apparatus, a method, an integrated circuit, a computer program, a storage medium, or any selective combination thereof.

### Advantageous Effects of Invention

According to a non-limiting and exemplary embodiment, it is possible for the pedestrian or the like to cross a road more safely.

Additional benefits and advantages of one aspect of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 illustrates an exemplary configuration of an in-vehicle system according to an embodiment of the present disclosure;

FIG. 2 is an explanatory view for explaining processing of Example 1 of projection of the crosswalk pattern according to the present embodiment;

FIG. 3 is a flowchart of the processing of Example 1 of the projection of the crosswalk pattern according to the present embodiment;

FIG. 4 is an explanatory view for explaining processing of Example 2 of the projection of the crosswalk pattern according to the present embodiment;

FIG. 5 is a flowchart of the processing of Example 2 of the projection of the crosswalk pattern according to the present embodiment;

FIG. 6 is an explanatory view for explaining processing of Example 3 of the projection of the crosswalk pattern according to the present embodiment; and

FIG. 7 is a flowchart of the processing of Example 3 of the projection of the crosswalk pattern according to the present embodiment.

### DESCRIPTION OF EMBODIMENTS

Embodiments of the invention will be described in detail below with appropriate reference to the accompanying drawings. However, descriptions detailed more than necessary may be omitted. For example, a detailed description of well-known matters and redundant descriptions on substantially the same configuration may be omitted. This is to avoid the unnecessary redundancy of the following description and to facilitate understanding by those skilled in the art.

Note that, the accompanying drawings and the following description are provided to enable those skilled in the art to fully understand the present disclosure, but are not intended to limit the claimed subject.

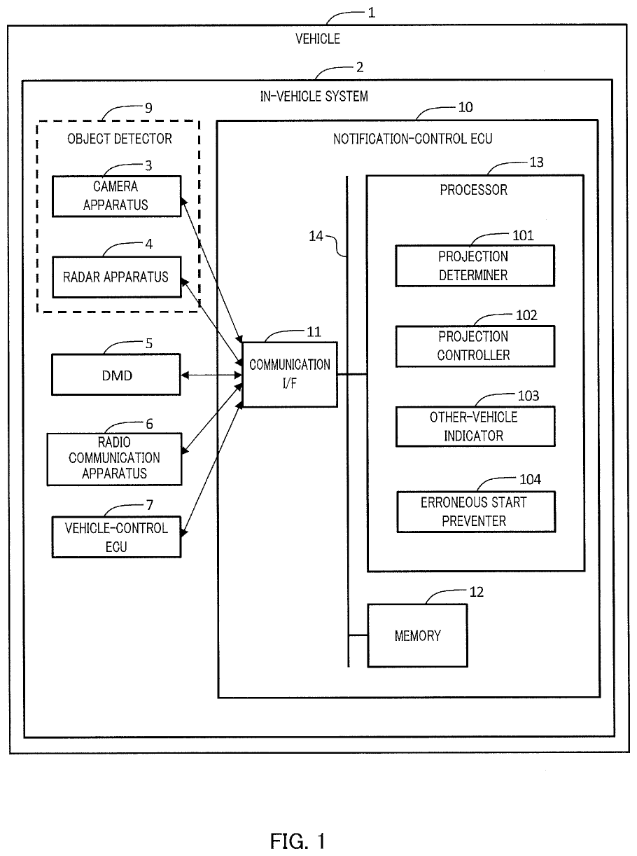

FIG. 1 illustrates an exemplary configuration of an in-vehicle system according to an embodiment of the present disclosure.

In-vehicle system 2 mounted in vehicle 1 includes, for example, camera apparatus 3, radar apparatus 4, Digital Micromirror Device (DMD) 5, radio communication apparatus 6, vehicle-control Electronic Control Unit (ECU) 7 and notification-control ECU 10.

Camera apparatus 3 is installed, for example in the front of vehicle 1, and detects an object (a person, a bicycle, another vehicle, an obstacle, or the like) ahead of vehicle 1 on the basis of a captured image. Radar apparatus 4 is installed, for example, in the front, rear, left, and right of vehicle 1, transmits an electromagnetic wave (e.g., millimeter wave), and detects an object neighboring vehicle 1 on the basis of the reflected electromagnetic wave.

Note that, camera apparatus 3 and radar apparatus 4 are one example of an apparatus for detecting the object neighboring vehicle 1, and vehicle 1 may detect the object with an apparatus other than these. Note also that, the apparatus for detecting the object, such as camera apparatus 3 and radar apparatus 4 may also be called object detector 9. Object detector 9 may indicate, to notification-control ECU 10, detection information including a detection result when the object is detected.

DMD 5 is an apparatus installed, for example, near the bumper of vehicle 1 and is for projecting a pattern, a character, and/or the like onto a road. In the present embodiment, DMD 5 projects the crosswalk pattern or the like onto the road ahead of vehicle 1 on the basis of control by notification-control ECU 10.

Radio communication apparatus 6 is an apparatus for communicating with another vehicle. For example, radio communication apparatus 6 performs inter-vehicle radio communication with the other vehicle on the basis of V2V (Vehicle to Vehicle) standard.

Vehicle-control ECU 7 is an apparatus for controlling operation of vehicle 1. For example, vehicle-control ECU 7 controls steering, an accelerator, a brake, and the like of vehicle 1. In the present embodiment, vehicle-control ECU 7 prevents an erroneous start of vehicle 1 on the basis of the control by notification-control ECU 10. That is, vehicle-control ECU 7 prevents vehicle 1 from starting when a driver steps on the accelerator erroneously.

Notification-control ECU 10 is an apparatus for controlling notification from vehicle 1 to the pedestrian or the like and to the other vehicle. Notification-control ECU 10 includes communication I/F 11, memory 12, and processor 13, for example. Communication I/F 11, memory 12, and processor 13 are connected to one another by internal bus 14 capable of bidirectional communication.

Communication I/F 11 transmits or receives data through an in-vehicle network to or from each of camera apparatus 3, radar apparatus 4, DMD 5, radio communication apparatus 6, and vehicle-control ECU 7. The in-vehicle network may be composed of either a wired network or a wireless network, or, of a combination thereof. Also, the in-vehicle network may at least partly be composed of a Controller Area Network (CAN).

Memory 12 holds a computer program to be executed by processor 13, data, and the like. Memory 12 is composed of a volatile memory or a nonvolatile memory, or a combination thereof.

Processor 13 implements various functions of notification-control ECU 10 by reading the computer program from memory 12 and executing the computer program. Processor 13 may be expressed as a Central Processing Unit (CPU), Large Scale Integration (LSI), or controller.

For example, processor 13 implements functions related to projection determiner 101, projection controller 102, other-vehicle indicator 103, and erroneous start preventer 104 by executing the computer program read out from memory 12.

Projection determiner 101 determines, on the basis of the detection information transmitted from object detector 9, whether or not the crosswalk pattern should be projected. For example, in a case where a pedestrian or the like waiting to cross a road is detected ahead of vehicle 1, projection determiner 101 determines, based on the detection information, that projection determiner 101 should project the crosswalk pattern. Note that, the case where the pedestrian or the like waiting to cross the road is detected may, for example, be a case where the pedestrian or the like is detected obliquely ahead of vehicle 1 on the basis of the captured image and/or the reflected wave.

In addition, in a case where a road sign of a stop is detected on the basis of the detection information ahead of vehicle 1 on a road which a pedestrian or the like is allowed to cross, projection determiner 101 determines on the basis of the detection information that projection determiner 101 should project the crosswalk pattern. Note that, the case where the road sign of a stop is detected may, for example, be a case where a road sign of “STOP” is detected on a road surface or on a signboard obliquely ahead of vehicle 1 using the captured image. Note also that, projection determiner 101 may determine, on the basis of a road sign, map information, and/or the like, whether or not the pedestrian or the like is allowed to cross the road.

Projection determiner 101 may also determine that the crosswalk pattern should be projected, when the driver instructs to project the crosswalk pattern.

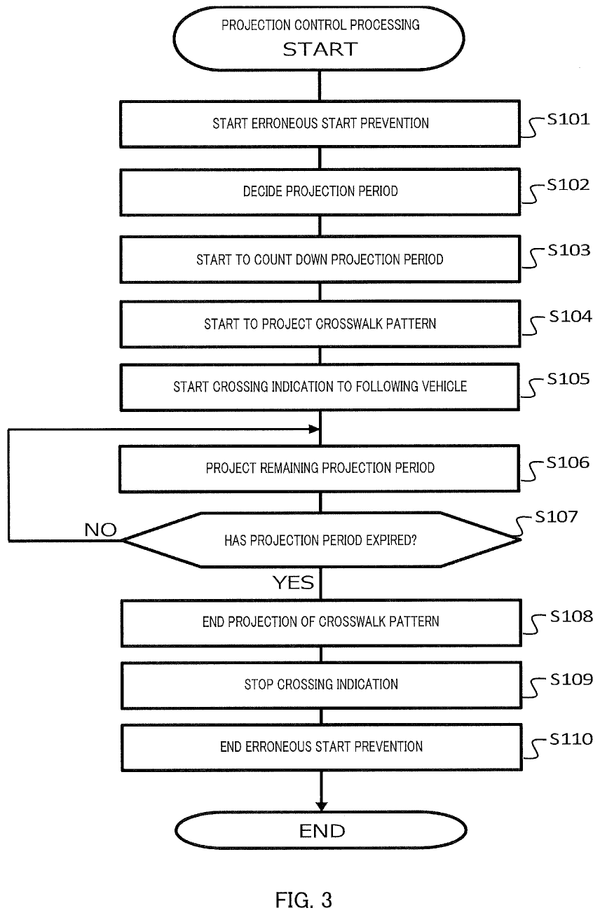

When projection determiner 101 determines that the crosswalk pattern should be projected, projection controller 102 controls DMD 5 such that the crosswalk pattern is projected ahead of vehicle 1. For example, when object detector 9 detects that an object existing ahead of vehicle 1 is a pedestrian or a bicycle, projection controller 102 controls DMD 5 such that the crosswalk pattern is projected for the pedestrian or the bicycle. Note that, projection controller 102 will be described in detail below (see FIGS. 3 to 7).

Other-vehicle indicator 103 indicates, to a following vehicle that succeeds vehicle 1, information indicating that a pedestrian or the like is crossing a road on the crosswalk pattern. The information is indicated by means of radio communication apparatus 6 during projection of the crosswalk pattern. Hereinafter, such indication is referred to as “crossing indication.” It is possible for the following vehicle that succeeds vehicle 1 to know, by receiving the crossing indication, the reason why front vehicle 1 has been stopping. Note that, other-vehicle indicator 103 may also display the information indicating that the pedestrian or the like is crossing the road on the crosswalk pattern, for example, on a display apparatus (not illustrated) installed in the rear of vehicle 1. Note also that, the crossing indication may also be expressed as an indication of information indicating that the crosswalk pattern is being projected (such an indication is referred to as “projection indication”).

Erroneous start preventer 104 controls vehicle-control ECU 7 during the projection period of the crosswalk pattern to prevent the erroneous start of vehicle 1. For example, during the projection period of the crosswalk pattern, erroneous start preventer 104 instructs vehicle-control ECU 7 such that vehicle 1 is not started even when the driver steps on the accelerator. It is thus possible to prevent vehicle 1 from erroneously starting during when the pedestrian or the like is crossing the road on the crosswalk pattern being projected onto the road.

(Example 1 of Projection of Crosswalk Pattern)

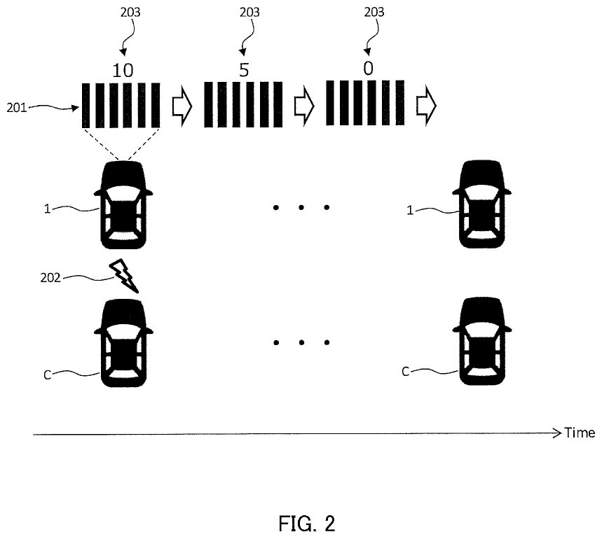

Next, the processing of Example 1 of the projection of the crosswalk pattern is described with reference to the explanatory view of FIG. 2 and the flowchart of FIG. 3. The processing described next is carried out when projection determiner 101 determines that the crosswalk pattern should be projected.

Erroneous start preventer 104 controls vehicle-control ECU 7 to starts erroneous start prevention (S101).

Projection controller 102 decides a projection period of crosswalk pattern 201 (S102). The projection period may be defined in advance. Alternatively, the projection period may also be decided on the basis of a road width, an expected crossing speed of a pedestrian or the like, and/or the like. For example, projection controller 102 may set the projection period such that the greater the road width is, the longer the projection period is, and/or, such that the slower the expected crossing speed of the pedestrian or the like is, the longer the projection period is.

Projection controller 102 starts to count down the projection period decided at S102 (S103). Projection controller 102 also controls DMD 5 to start the projection of crosswalk pattern 201 (S104).

Other-vehicle indicator 103 starts crossing indication 202 to following vehicle C that succeeds vehicle 1 (S105).

Projection controller 102 controls DMD 5 such that information 203 indicating a remaining projection period is projected in the vicinity of crosswalk pattern 201 (S106). For example, projection controller 102 causes projection of a numeral indicating the remaining projection period as illustrated in FIG. 2. Alternatively, projection controller 102 may also cause projection of a bar graph that decreases in length according to the remaining projection period.

Projection controller 102 determines whether or not the projection period has expired (S107), and, when the projection period has not expired (S107: NO), projection controller 102 returns to S106, continues to project crosswalk pattern 201, and projects information 203 indicating an updated remaining projection period.

When the projection period has expired (S107: YES), projection controller 102 controls DMD 5 to end the projection of crosswalk pattern 201 (S108).

In addition, other-vehicle indicator 103 stops crossing indication 202 (S109). In addition, erroneous start preventer 104 controls vehicle-control ECU 7 to end the erroneous start prevention (S101).

According to the above processing, vehicle 1 projecting the crosswalk pattern is prevented from starting erroneously, so that it is possible for the pedestrian or the like to cross a road on crosswalk pattern 201 more safely. Moreover, vehicle 1 projecting the crosswalk pattern provides crossing indication 202 to following vehicle C, so that it is possible for following vehicle C to know the reason why front vehicle 1 has been stopping. This makes it possible to prevent following vehicle C from passing front vehicle 1 to go into crosswalk pattern 201. That is, it is possible for the pedestrian or the like to cross the road more safely on crosswalk pattern 201 being projected by vehicle 1.

Furthermore, according to the above processing, it is possible for the pedestrian or the like to know the remaining projection period of crosswalk pattern 201 by information 203 indicating the remaining projection period and projected in the vicinity of crosswalk pattern 201. It is thus possible for the pedestrian or the like to cross the road more smoothly.

Note that, the processing described above is one example and part of the processing does not have to be practiced in the present embodiment. For example, information 203 indicating the remaining projection period does not have to be projected in the present embodiment. Crossing indication 202 to following vehicle C also does not have to be provided in the present embodiment.

(Example 2 of Projection of Crosswalk Pattern)

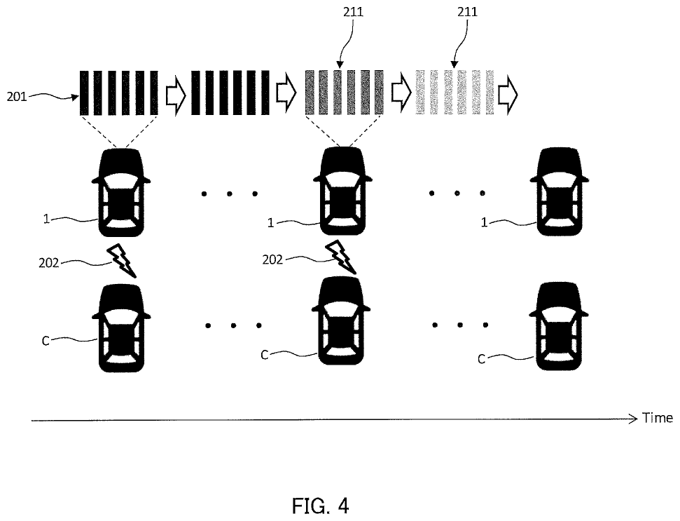

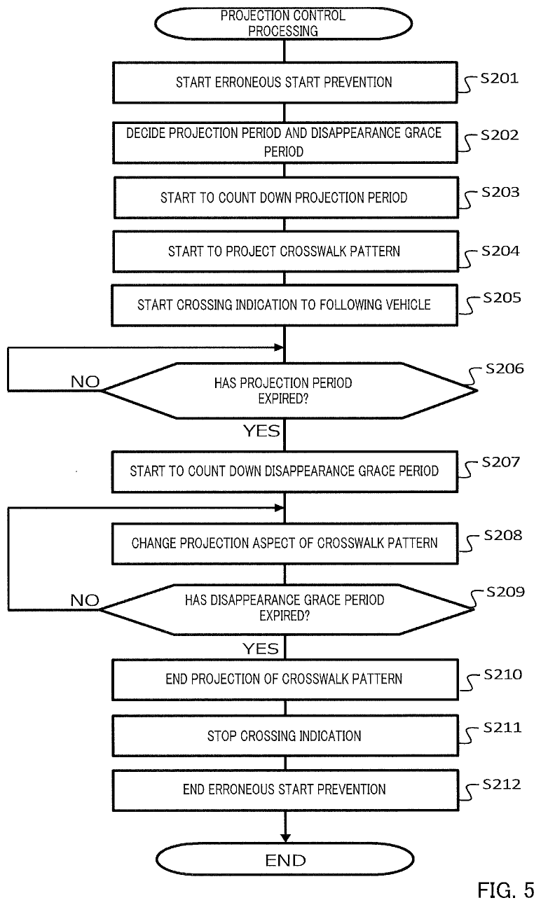

Next, the processing of Example 2 of the projection of the crosswalk pattern is described with reference to the explanatory view of FIG. 4 and the flowchart of FIG. 5. Like in aforementioned Example 1, the processing described next is carried out when projection determiner 101 determines that the crosswalk pattern should be projected.

Erroneous start preventer 104 controls vehicle-control ECU 7 to start the erroneous start prevention (S201).

Projection controller 102 decides the projection period of crosswalk pattern 201 as in step S102. Projection controller 102 also decides a disappearance grace period of crosswalk pattern 201 (S202). The disappearance grace period is a period from the expiration of the projection period until the end of projection of crosswalk pattern 201. The disappearance grace period may be defined in advance. Alternatively, the disappearance grace period, like the projection period, may also be decided on the basis of a road width, an expected crossing speed of a pedestrian or the like who is to cross a road, and/or the like. For example, projection controller 102 may set the disappearance grace period such that the greater the road width is, the longer the disappearance grace period is, and/or, such that the slower the expected crossing speed of the pedestrian or the like is, the longer the disappearance grace period is.

As in steps S103 and S104 in FIG. 3, projection controller 102 starts to count down the projection period (S203), and starts to project crosswalk pattern 201 (S204). In addition, other-vehicle indicator 103 starts crossing indication 202 to following vehicle C as in step S105 (S205).

Projection controller 102 determines whether or not the projection period has expired (S206), and, when the projection period has not expired (S206: NO), projection controller 102 returns to S206, and continues to project the crosswalk pattern. When the projection period has expired (S206: YES), projection controller 102 starts to count down the disappearance grace period (S207).

Then, during the disappearance grace period, projection controller 102 changes a projection aspect of crosswalk pattern 201 differently from the projection aspect during the projection period (S208). Specifically, projection controller 102 changes the projection aspect of crosswalk pattern 201 differently from the projection aspect during the projection period in terms of a projection intensity or a color, or into flashing projection. For example, projection controller 102 makes smaller the projection intensity 211 of crosswalk pattern 201 according to the remaining disappearance grace period as illustrated in FIG. 4. Alternatively, projection controller 102 changes the interval of flashing of crosswalk pattern 201 according to the remaining disappearance grace period. Alternatively, projection controller 102 changes the color of crosswalk pattern 201 according to the remaining disappearance grace period.

Projection controller 102 determines whether or not the disappearance grace period has expired (S209), and, when the disappearance grace period has not expired (S209: NO), projection controller 102 returns to S208, and continues to project the crosswalk pattern in the disappearance grace period. When the disappearance grace period has expired (S209: YES), the processing of S210 is carried out.

In the processing after S210, projection controller 102, other-vehicle indicator 103, and erroneous start preventer 104 perform the same processing as those of S108 to S110 (S210 to S212).

According to the above processing, vehicle 1 projecting crosswalk pattern 201 is prevented from starting erroneously, so that it is possible for the pedestrian or the like to cross the road on crosswalk pattern 201 more safely. Moreover, vehicle 1 projecting crosswalk pattern 201 provides crossing indication 202 to following vehicle C, so that it is possible for following vehicle C to know the reason why front vehicle 1 has been stopping.

Furthermore, according to the above processing, the change in projection aspect of crosswalk pattern 201 makes it possible for the pedestrian or the like to know that crosswalk pattern 201 disappears soon. It is thus possible for the pedestrian or the like to cross the road more smoothly and safely.

Note that, in the processing of Example 2 described above, notification-control ECU 10 may also project the remaining projection period described for Example 1 until the projection period expires.

(Example 3 of Projection of Crosswalk Pattern)

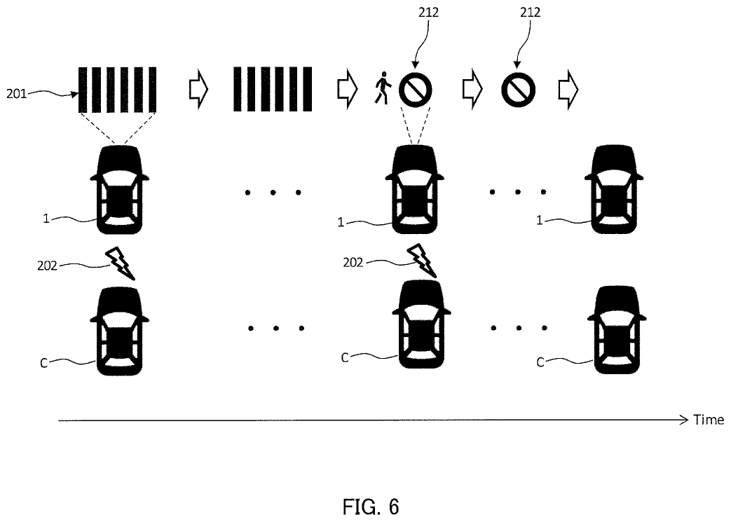

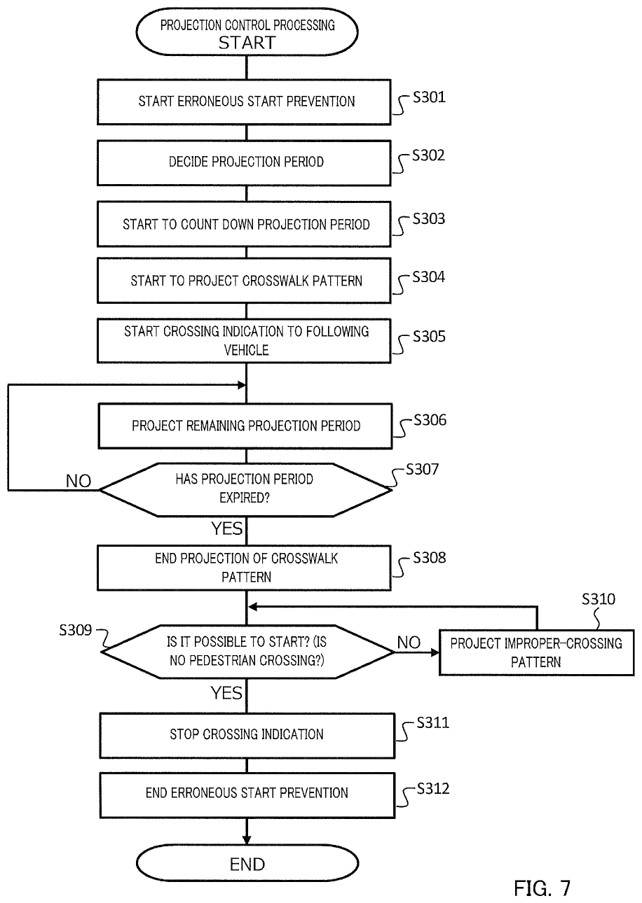

Next, Example 3 of the projection of the crosswalk pattern is described with reference to the explanatory view of FIG. 6 and the flowchart of FIG. 7. Like in aforementioned Example 1, the processing described next is carried out when projection determiner 101 determines that the crosswalk pattern should be projected.

Erroneous start preventer 104, projection controller 102, and other-vehicle indicator 103 perform the same processing as those of S101 to S108 (S301 to S308).

After the end of projection of crosswalk pattern 201 at S308, projection controller 102 determines whether or not it is possible for vehicle 1 to start (S309). For example, when a pedestrian or the like who is crossing a road or who is highly likely to start to cross the road is detected on the basis of the detection information from object detector 9, projection controller 102 determines that it is impossible for vehicle 1 to start.

When projection controller 102 determines that it is impossible for vehicle 1 to start (S309: NO), projection controller 102 causes projection of pattern 212 indicating that it is improper to cross the road (hereinafter, such a pattern is referred to as “improper-crossing pattern 212”) (S310) as illustrated in FIG. 6, and returns to S309. That is, projection controller 102 continues projection of improper-crossing pattern 212 until projection controller 102 determines that it is possible for vehicle 1 to start. In addition, other-vehicle indicator 103 continues crossing indication 202 to following vehicle C that succeeds vehicle 1, until it is determined that it is possible for vehicle 1 to start.

When projection controller 102 determines that it is possible for vehicle 1 to start (S309: YES), projection controller 102 proceeds to S311. That is, other-vehicle indicator 103 stops crossing indication 202 to following vehicle C that succeeds vehicle 1 (S311), and erroneous start preventer 104 ends the erroneous start prevention (S312).

According to the above processing, in a case where there is the pedestrian or the like crossing the road, the erroneous start prevention for vehicle 1 is continued even after the projection of crosswalk pattern 201 is ended, so that it is possible for the pedestrian or the like to cross the road more safely. Moreover, in the case where there is the pedestrian or the like crossing the road, crossing indication 202 to following vehicle C is continued even after the projection of crosswalk pattern 201 is ended, so that it is possible for following vehicle C to know continuously the reason why front vehicle 1 has been stopping.

In addition, according to the above processing, improper-crossing pattern 212 projected onto the road allows the pedestrian or the like crossing the road to know that it is necessary to cross the road quickly, or, allows the pedestrian or the like who is highly likely to start to cross the road to know that s/he should not cross the road now. It is thus possible for the pedestrian or the like to cross the road more smoothly and safely.

Note that, in the processing of Example 3 described above, notification-control ECU 10 may also perform the processing of changing the projection aspect of the crosswalk pattern as described in Example 2 after the expiration of the projection period and before it is determined whether or not it is possible for vehicle 1 to start.

<Summary of Disclosure>

In the present disclosure, notification-control ECU 10 is provided in one vehicle, and includes projection controller 102 that controls projection of crosswalk pattern 201 onto a road ahead of vehicle 1, and erroneous start preventer 104 that prevents the erroneous start of vehicle 1 during the projection period of crosswalk pattern 201.

Vehicle 1 projecting the crosswalk pattern is thus prevented from starting erroneously, so that it is possible for the pedestrian or the like to cross the road on crosswalk pattern 201 more safely.

Note that, it is possible to express the present disclosure as follows.

A notification control apparatus according to the present disclosure is a notification control apparatus provided in a vehicle, and includes: a projection controller that controls projection of a crosswalk pattern onto a road ahead of the vehicle; and an erroneous start preventer that prevents an erroneous start of the vehicle during a projection period of the crosswalk pattern.

In addition, in the notification control apparatus according to the present disclosure, the erroneous start preventer may prevent the erroneous start of the vehicle when an accelerator is erroneously stepped on.

In addition, in the notification control apparatus according to the present disclosure, the projection controller may decide the projection period on the basis of at least one of a road width and an expected crossing speed of a pedestrian.

In addition, in the notification control apparatus according to the present disclosure, the projection controller may control projection of information indicating a remaining period of a predetermined projection period.

In addition, in the notification control apparatus according to the present disclosure, the projection controller may control projection of a bar graph that decreases in length according to the projection period remaining.

In addition, in the notification control apparatus according to the present disclosure, the projection controller may change an aspect of the crosswalk pattern such that the aspect of the crosswalk pattern during a disappearance grace period set to commence after expiration of a predetermined projection period is different from the aspect of the crosswalk pattern during the predetermined projection period.

In addition, in the notification control apparatus according to the present disclosure, the projection controller may change the aspect of the crosswalk pattern according to a remaining period of the disappearance grace period set to commence after the expiration of the predetermined projection period.

In addition, in the notification control apparatus according to the present disclosure, the projection controller may decide the disappearance grace period on the basis of at least one of a road width and an expected crossing speed of a pedestrian.

In addition, the notification control apparatus according to the present disclosure further includes a projection determiner that determines, on the basis of at least one of a road sign and map information, whether or not the crosswalk pattern is to be projected. The projection controller may control the projection of the crosswalk pattern when the projection determiner determines that the crosswalk pattern is to be projected.

In addition, the notification control apparatus according to the present disclosure may further include an other-vehicle indicator that indicates, to a following vehicle during the projection period of the crosswalk pattern, that the crosswalk pattern is being projected.

In addition, in the notification control apparatus according to the present disclosure, when it is detected that an object existing ahead of the vehicle is a pedestrian or a bicycle, the projection controller may control the projection of the crosswalk pattern for the pedestrian or the bicycle.

In addition, in the notification control apparatus according to the present disclosure, when a pedestrian or a bicycle crossing the road is detected ahead of the vehicle after expiration of the projection period of the crosswalk pattern, the projection controller may control projection of an improper-crossing pattern.

In addition, a non-transitory storage medium storing therein a computer program according to the present disclosure causes a computer mounted in a vehicle to execute processing of: controlling projection of a crosswalk pattern onto a road ahead of the vehicle; and preventing an erroneous start of the vehicle during a projection period of the crosswalk pattern.

In addition, an in-vehicle system according to the present disclosure is a notification control apparatus provided in a vehicle, and includes: an object detector that detects a pedestrian or a bicycle existing ahead of the vehicle; a projection controller that controls projection of a crosswalk pattern onto a road ahead of the vehicle when the pedestrian or the bicycle is detected; and an erroneous start preventer that prevents an erroneous start of the vehicle during a projection period of the crosswalk pattern.

The present disclosure can be realized by software, hardware, or software in cooperation with hardware.

Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system which can be mounted in a vehicle. Some non-limiting examples of such an apparatus include a phone (e.g., cellular (cell) phone, smart phone), a tablet, a personal computer (PC) (e.g., laptop, desktop, notebook), a camera (e.g., digital still/video camera), a digital player (digital audio/video player), a wearable device (e.g., wearable camera, smart watch, tracking device), a game console, and a vehicle or a means of movement and transportation (e.g., automotive, airplane, ship), and various combinations thereof.

While various embodiments have been described herein above, it is to be appreciated that various changes in form and detail may be made without departing from the sprit and scope of the invention(s) presently or hereafter claimed.

This application is entitled to and claims the benefit of Japanese Patent Application No. 2018-237302 dated Dec. 19, 2018, the disclosure of which including the specification, drawings and abstract is incorporated herein by reference in its entirety.

### INDUSTRIAL APPLICABILITY

One aspect of the present disclosure is useful for in-vehicle systems.

### REFERENCE SIGNS LIST

1 Vehicle
2 In-vehicle system
3 Camera apparatus
4 Radar apparatus
5 DMD
6 Radio communication apparatus
7 Vehicle-control ECU
9 Object detector
10 Notification-control ECU
11 Communication I/F
12 Memory
13 Processor
14 Internal bus
101 Projection determiner
102 Projection controller
103 Other-vehicle indicator
104 Erroneous start preventer

1. A notification control apparatus provided in a vehicle, the notification control apparatus comprising:
a projection controller that controls projection of a crosswalk pattern onto a road ahead of the vehicle; and
an erroneous start preventer that prevents an erroneous start of the vehicle during a projection period of the crosswalk pattern.

2. The notification control apparatus according to claim 1, wherein
the erroneous start preventer prevents the erroneous start of the vehicle when an accelerator is erroneously stepped on.

3. The notification control apparatus according to claim 1, wherein
the projection controller decides the projection period on the basis of at least one of a road width and an expected crossing speed of a pedestrian.

4. The notification control apparatus according to claim 1, wherein
the projection controller controls projection of information indicating a remaining period of a predetermined projection period.

5. The notification control apparatus according to claim 4, wherein
the projection controller controls projection of a bar graph that decreases in length according to the projection period remaining.

6. The notification control apparatus according to claim 1, wherein
the projection controller changes an aspect of the crosswalk pattern such that the aspect of the crosswalk pattern during a disappearance grace period set to commence after expiration of a predetermined projection period is different from the aspect of the crosswalk pattern during the predetermined projection period.

7. The notification control apparatus according to claim 6, wherein
the projection controller changes the aspect of the crosswalk pattern according to a remaining period of the disappearance grace period set to commence after the expiration of the predetermined projection period.

8. The notification control apparatus according to claim 7, wherein
the projection controller decides the disappearance grace period on the basis of at least one of a road width and an expected crossing speed of a pedestrian.

9. The notification control apparatus according to claim 1, further comprising:
a projection determiner that determines, on the basis of at least one of a road sign and map information, whether or not the crosswalk pattern is to be projected, wherein
the projection controller controls the projection of the crosswalk pattern when the projection determiner determines that the crosswalk pattern is to be projected.

10. The notification control apparatus according to claim 1, further comprising:
an other-vehicle indicator that indicates, to a following vehicle during the projection period of the crosswalk pattern, that the crosswalk pattern is being projected.

11. The notification control apparatus according to claim 1, wherein,
when it is detected that an object existing ahead of the vehicle is a pedestrian or a bicycle, the projection controller controls the projection of the crosswalk pattern for the pedestrian or the bicycle.

12. The notification control apparatus according to claim 1, wherein,
when a pedestrian or a bicycle crossing the road is detected ahead of the vehicle after expiration of the projection period of the crosswalk pattern, the projection controller controls projection of an improper-crossing pattern.

13. A non-transitory storage medium storing therein a computer program for causing a computer mounted in a vehicle to execute processing of:
controlling projection of a crosswalk pattern onto a road ahead of the vehicle; and
preventing an erroneous start of the vehicle during a projection period of the crosswalk pattern.

14. An in-vehicle system provided in a vehicle, the in-vehicle system comprising:
an object detector that detects a pedestrian or a bicycle existing ahead of the vehicle;
a projection controller that controls projection of a crosswalk pattern onto a road ahead of the vehicle when the pedestrian or the bicycle is detected; and
an erroneous start preventer that prevents an erroneous start of the vehicle during a projection period of the crosswalk pattern.
